(19) United States
(12) Patent Application Publication
(10) Pub. No.: US 2022/0228646 A1
(43) Pub. Date: Jul. 21, 2022

(54) Swing Gear Assembly and Method for Manufacturing the Same

(71) Applicant: Caterpillar Global Mining LLC, Tucson, AZ (US)

(72) Inventors: Christopher R. Wanasek, Waterford, WI (US); Jason M. Schmidt, Tucson, AZ (US)

(73) Assignee: Caterpillar Global Mining LLC, Tucson, AZ (US)

(21) Appl. No.: 17/154,567

(22) Filed: Jan. 21, 2021

(51) Int. Cl. F16H 1/10; F16H 55/08; F16H 55/17; B21K 1/30

(52) U.S. Cl. CPC F16H 1/10; F16H 55/08; F16H 2055/176; B21K 1/30; F16H 55/17

(57) ABSTRACT

A swing gear set for a large scale or heavy machine can be produced from components of a swing gear set including an internal gear ring assembled from plurality of internal toothed segments and/or an external gear ring assembled from a plurality of external toothed segments. The internal toothed segments and/or the external toothed segments are produced by bisecting a metal block in the shape of a rectangular prism into first and second intermediate blanks. The metal block can be produced by a forging process and the intermediate blanks can be machined by various machining process to produce the finished internal and external toothed segments.

### TECHNICAL FIELD

This patent disclosure relates generally to a swing gear assembly to provide a rotatable interface between a rotatable upper structure and a lower base of a large scale or heavy machine, and more particular the disclosure relates to a method of manufacturing gear segments from which the swing gear assembly can be assembled.

### BACKGROUND

Large scale and heavy machines like dragline excavators, rope shovels, and rotary cargo container cranes are used in operations like mining, material excavation, and cargo transportation. These machines may include an extended truss assembly from which a work implement can be suspended. For example, a dragline excavator can include a dragline bucket suspended several meters forward of the machine. The dragline bucket can be lowered to the excavation surface and drawn toward the machine via wire ropes or chains so that excavation material is deposited into the dragline bucket. The machines can perform a swing-and-dump maneuver that swings the truss assembly with respect to a vertical axis of the machine to deposit the excavated material or, in the case of a rotary cargo container crane, the cargo container.

To enable the swing-and-dump maneuver, the machine can have a swing assembly including in particular a swing gear assembly that functions as the interface between and joins an upper structure of the machine from which the truss assembly is suspended to a lower base on which the machine is supported on the work surface. The swing gear assembly may include an internal gear ring or an external gear ring that meshes with and can be driven by a round pinon to rotate the upper structure. In the example of these large machines like dragline excavators where the truss assembly may extend a hundred meters or more and the bucket may hold several tons of material, it will be appreciated that the swing gear assembly can be several meters in diameter and can be made from high strength materials like steel or iron. Moreover, because of their size, many types of these heavy machines are configured to be built onsite from components that must be transported to the needed location. Accordingly, to facilitate manufacture and transportation of the swing gear assembly, it may be configured as a segmented gear assembly in which the intermeshing gears are assembled from a plurality of individual gear segments in the form of partial angular arcs that can be combined to provide the entire circular circumference of the swing gear assembly.

The present disclosure is directed to gear segments and methods of producing gear segments as described above for forming a swing gear assembly for a large scale or heavy duty machine like a dragline excavator.

### SUMMARY

The disclosure describes, in one aspect, a method of producing a gear set for a large scale or heavy machine. The method involves forging a metal block from raw material that has the shape of a rectangular prism including a first lengthwise face and a second lengthwise face and an upper face and a lower face. The metal block is bisected into a first intermediate blank and a second intermediate blank by a diagonal cut disposed between the upper face and the lower face. A plurality of arranged teeth is milled into the first lengthwise face of the first intermediate blank to produce one of an internal toothed segment and an external toothed segment. Similarly, a plurality of arranged teeth is milled into the second lengthwise face of the second intermediate blank to produce one of an internal toothed segment and an external toothed segment.

In another aspect, the disclosure describes a gear set including a gear ring with a plurality of teeth. The gear ring may include a first toothed segment having a plurality of gear teeth disposed into a first lengthwise face of a first intermediate blank from which one of the plurality of the toothed segments is machined. The gear ring may also include a second toothed segment having a plurality of gear teeth disposed into a second lengthwise face of a second intermediate blank from which the one of the plurality of the toothed segments is machined. The first intermediate blank and the second intermediate blank are commonly bisected from a metal block.

In another aspect, the disclosure describes a gear ring assembled from a plurality of gear segments. Each gear segment includes an upper face and a lower face parallel to and spaced apart from the upper face. Each gear segment further includes a lengthwise face extending between the upper face and the lower face with a plurality of teeth disposed therein. Each gear segment further includes a lengthwise edge parallel to and spaced apart from the lengthwise face and extending partially between the upper face and the lower face. The plurality of teeth is selected from the group comprising internal teeth concavely disposed in the lengthwise face and a plurality of external teeth convexly disposed in the lengthwise face.

### BRIEF DESCRIPTION OF THE DRAWINGS

FIG. 1 is a side elevational view of a dragline excavator for excavating earthen materials that includes a rotatable upper structure supported on a lower base joined by a swing gear assembly.

FIG. 2 is a perspective view of the swing gear assembly made from a plurality of external toothed segments or internal toothed segments.

FIG. 3 is a perspective view of a forged metal block in the shape of a rectangular prism from which the plurality of external toothed segments and internal toothed segments can be manufactured.

FIG. 4 is a side elevational view of the metal block illustrating various cuts that may be machined into the metal block to produce a first intermediate blank and a second intermediate blank.

FIG. 5 is a perspective view of an internal toothed segment having a plurality of concavely arranged teeth manufactured from the first and/or second intermediate blank.

FIG. 6 is a perspective view of an external toothed gear segment having a plurality of convexly arranged teeth manufactured from the first and/or second intermediate blank.

FIG. 7 is a schematic representation of the manufacturing steps for the production of external and internal toothed segments from a metal block in accordance with the disclosure.

### DETAILED DESCRIPTION

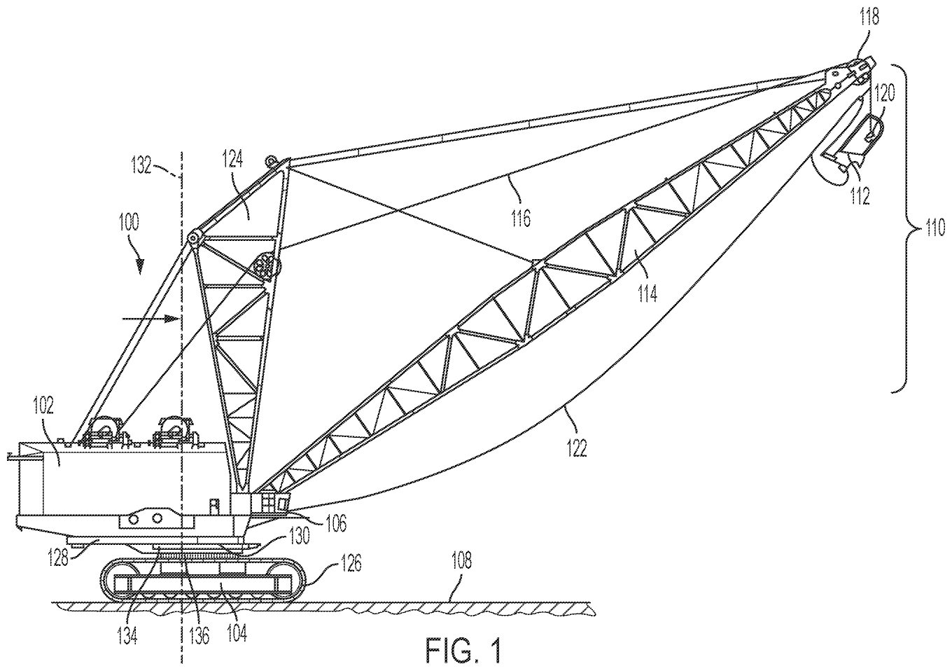

This disclosure relates to a swing gear assembly for rotatably joining an upper structure to a lower base on large scale or heavy machines used for earthwork operations, large scale construction operations, or cargo handling. Referring to FIG. 1, wherein like reference numbers refer to like elements, there is illustrated an example of a heavy machine in the embodiment of a dragline excavator 100 used in earthwork operations such as material excavation and surface mining. Aspects of the disclosure, however, are applicable to other large scale or heavy machines such as rope shovels, cranes, and other types of excavators. The illustrated embodiment of the dragline excavator 100 includes an upper structure 102 that is supported on and rotatable with respect to a lower base 104. The upper structure 102, which may also be referred to as a house or cabin, internally accommodates the motors or engines and the hoist and drag mechanisms for powering the operations of the dragline excavator 100 and which may include an operator's cab 106 located at front of the upper structure from where an operator can observe and control operation of the dragline excavator. The lower base 104 supports the upper structure 102 and contacts the work surface 108 or excavation surface.

Joined to and extending from the upper structure 102 can be a frame or truss assembly 110 which includes the truss components and rigging that support and maneuver a dragline bucket 112. The dragline bucket 112 may be suspended from a boom 114 that extends upward and outward from the front of the upper structure 102 and can be maneuvered by various ropes, cables, or chains. For example, the dragline bucket 112 can be raised and lowered with respect to the work surface 108 by a hoist line 116 that extends along the boom 114 through a sheave 118 at the distal end of the boom and connects to a hoist coupler 120 on the dragline bucket 112. The dragline bucket 112 can also be drawn horizontally over the excavation surface by a drag line 122. In operation, for example, to remove overburden that may be located over the material of interest such as coal or other minerals, the dragline bucket 112 is lowered and penetrates into the work surface 108 via the hoist line 116 and drawn toward the upper structure 102 by the drag line 122 thereby gathering material in the bucket. The hoist line 116 and drag line 122 can be retracted and payed out by appropriate drums located in the upper structure 102 and which the lines are wound around. To support the boom 114 during movement of the dragline bucket 112, the truss assembly 110 can also include a vertical brace 124 that extends upwardly from the upper structure 102.

By way of example, the length of the boom 114 can be a hundred meters or more and the capacity of the bucket 112 can be a hundred tons or more of material. The loads on the hoist line 116 and drag line 122 are significant and can be on the order of hundreds of thousands of foot-pounds of tensile stress. The hoist and drag lines 116, 122 can be made from high strength steels wires twisted into a helix and can have diameters on the order of twelve or more centimeters. Accordingly, to counterbalance hoisting and maneuvering of the dragline bucket 112 when loaded, the upper structure 102 that accommodates the hoist and drag machinery can weigh several hundred tons. Correspondingly, the length of the upper structure 102 can be thirty meters or greater and can have a correspondingly large width.

To traverse and maneuver the dragline excavator 100 over the work surface 108, the lower base 104 can include appropriate propulsion devices 126 such as continuous tracks formed from a band of linked track plates that can translate with respect to the lower base 104, thereby moving the upper structure 102 over the work surface 108. In other embodiments, the propulsion devices 126 can be a walker or crawler unit wherein support feet or shoes can be eccentrically lifted and lowered with respect to the work surface 108 and thereby move the upper structure 102 forward or rearward over the work surface 108. Although the embodiment of a dragline excavator 100 described herein is a type of mobile machine, aspects of the disclosure may also relate to large scale or heavy stationary or fixed machines, such as cargo cranes and the like.

One step in an excavation operation is a swing and dump operation. In this step, the upper structure 102 is pivoted with respect to the work surface 108 to move the dragline bucket 112 from the location where it has excavated material to a location where the dragline excavator 100 deposits the material for removal from the excavation site. For example, the material may be deposited on an in-site conveyor or a haul truck. To enable the dragline excavator 100 to conduct the swing and dump operation, the upper structure 102 is located on a swing platform 128 that is rotatably joined to the lower base 104 by a swing assembly 130 so that the upper structure 102 is rotatable relative to the lower base 104 about a vertical axis line 132. The swing assembly 130 can include a roller bearing 134 that carries the load of the upper structure 102 while enabling relative rotational motion between the upper structure 102 and the lower base 104 with respect to the axis line 132. Due to the size and weight of the upper structure 102, it will be appreciated that the swing assembly 130 supports a significant load, possibly on the order of several hundred tons.

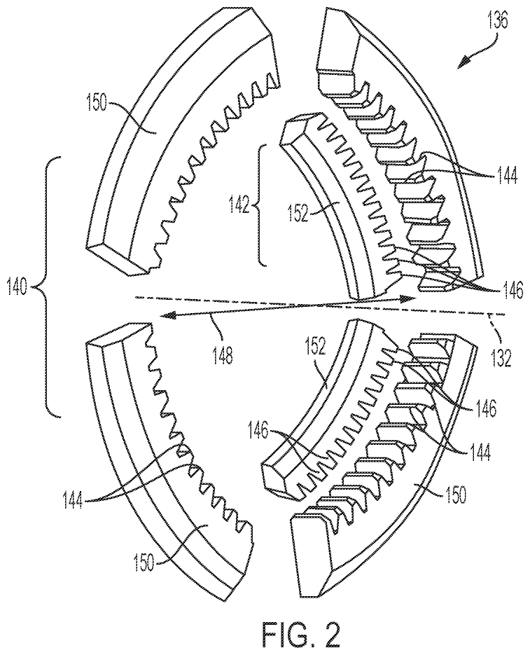

To drive rotation of the upper structure 102 with respect to the lower base 104, the swing assembly 130 can be made from components of a gear set 136 on which the swing platform 128 is mounted and that can be operatively associated with a motor accommodated in the upper structure 102. Referring to FIG. 2, the gear set 136 can include an internal gear ring 140 and/or an external gear ring 142. In accordance with the disclosure, the internal and external gear rings 140, 142 can be produced together by a common manufacturing operation and one or the other of the internal or external gear rings can be used in the swing assembly 130 on the dragline excavator 100 or similar machine. For reference, the internal gear ring 140 and the external gear ring are concentrically aligned around the axis line 132 that corresponds to the axis of rotation of the swing assembly 130 when installed on the dragline excavator. When assembled, either the internal gear ring 140 or the external gear ring 142 is fixed to the lower base 104 and can mesh with one or more pinions extending from the upper structure 102 and driven by an electric motor or other power source. The upper structure 102 therefore rotates around the axis line 132 so that the upper structure 102 swings with respect to the lower base 104.

The internal gear ring 140 can be shaped as an annular ring and includes a plurality of radially inward directed internal teeth 144 and the external gear ring 142 can also be shaped as an annular ring and includes a plurality of radially outward directed external teeth 146. The internal gear ring 140 and the external gear ring 142 can be spur gears wherein the internal teeth 144 and the external teeth 146 extend over the height of the ring-shaped internal gear ring 140 and external gear ring 142 respectively so as to be parallel with the axis line 132. Further, the internal teeth 144 are circumferentially disposed about and spaced apart along the inner circular periphery of the internal gear ring 140 and the external teeth are circumferential disposed about and spaced apart along the outer circular periphery of the external gear ring 142. In the illustrated embodiment, the internal teeth 144 and the external teeth 146 can have an involute profile to facilitate intermeshing and sliding contact with respect to the gear teeth on a round pinion that drives rotation of the swing gear assembly 130. In other possible embodiments, however, the gear teeth may have other configurations such as helical.

Because of the size of the upper structure 102 including the truss assembly 110, it should be appreciated that the gear set 136 should have a correspondingly large size. For example, the pitch diameter 148 of the internal and external gear rings 140, 142, which is indicated schematically by the arrow and which may represent the diametrical dimension extending between the approximate midpoints within the depth of engagement between diametrically opposite inner and external teeth 144, 146, can be on the order of twelve meters or more.

To facilitate manufacturing of the internal and external gear rings 140, 142, and to facilitate transportation in the case where the dragline excavator is assembled onsite, the swing assembly 130 can be a segmented gear assembly in which the internal gear ring 140 and the external gear ring 142 are assembled from a plurality of arcuate gear segments including an internal toothed segment 150 and an external toothed segment 152. The arcuate-shaped internal toothed segments 150 can correspond to partial arcs that, when assembled together, complete the circumference of the internal gear ring 140. Likewise, the arcuate-shaped external toothed segments 152 can correspond to partial arcs that, when assembled together, complete the circumference of the external gear ring 142. The internal toothed segment 150 and the external toothed segment 152 can have various angular extensions, for example, 90° so that the internal gear ring 140 and the external gear ring 142 are made up of four identical internal toothed segments 150 and external toothed segments 152 respectively. However, other angular extensions are contemplated such that the internal gear ring 140 and the external gear ring 142 are made up of any suitable number of internal or external toothed segments 150, 152.

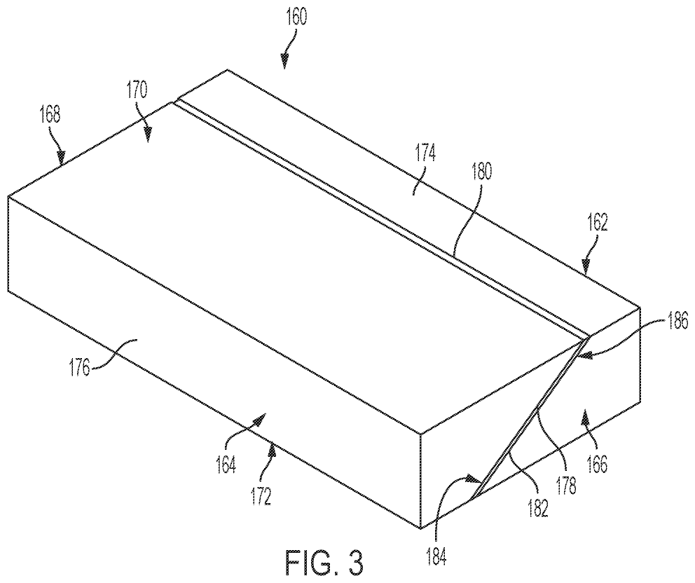

To manufacture the internal toothed segment 150 and/or the external toothed segment 152, multiple segments may be produced from the same metal block via specific cuts and machining steps. For example, referring to FIG. 3, there is illustrated an exemplary metal block 160 that can be shaped as a rectangular cuboid or rectangular prism from which the segments can be formed. As a rectangular prism, the metal block 160 has a three-dimensional geometry and can include six quadrilateral faces with adjacent faces intersecting at right angles and arranged perpendicular to each other. The quadrilateral faces can be designated as a first lengthwise face 162 and a parallel second lengthwise face 164 that can correspond to the forward and rearward faces of the metal block 160, a first end face 166 and a parallel second end face 168 that correspond to opposite lengthwise ends of the metal block 160 and define the width of the metal block between the first and second lengthwise faces 162, 164, and an upper face 170 and a parallel lower face 172 that define the vertical height of the metal block 160. To produce internal and external toothed segments suitably sized for a dragline excavator, the metal block 160 may have a length on the order of two meters or more, a width between the first and second lengthwise faces 162, 164 of one meter or more, and a height between the upper face 170 and the lower face 172 of thirty centimeters or more.

To provide sufficient strength characteristics to the internal and external toothed segments, the metal block 160 can be made from a suitable metal such as steel or iron. In an embodiment, the metal block 160 can be produced by a metalworking process and in particular formed from a forging process in which an initial quantity of metal produced as a casting or extruded ingot is compressed into the shape of the rectangular prism illustrated in FIG. 3. During the forging process, the metal is shaped by applied compressive forces, for example, by repeated strikes from a forging hammer or press and dies. The forging process plastically deforms the metal into the desired shape and can impart desirable strength characteristics and microstructural properties to the metal block 160. To improve formability where the metal block 160 is made from steel or iron, the forging process may be hot forging process where the initial casting or ingot is heated to a highly elevated temperature. After the metal block 160 has been forged, it may be subjected to additional heat treating processes to impart desirable characteristics such as to improve machinability and strength. In addition to the forging process, in other embodiments of the disclosure, other metal forming processes can be used to form the metal block 160 including, for example, casting and extrusion.

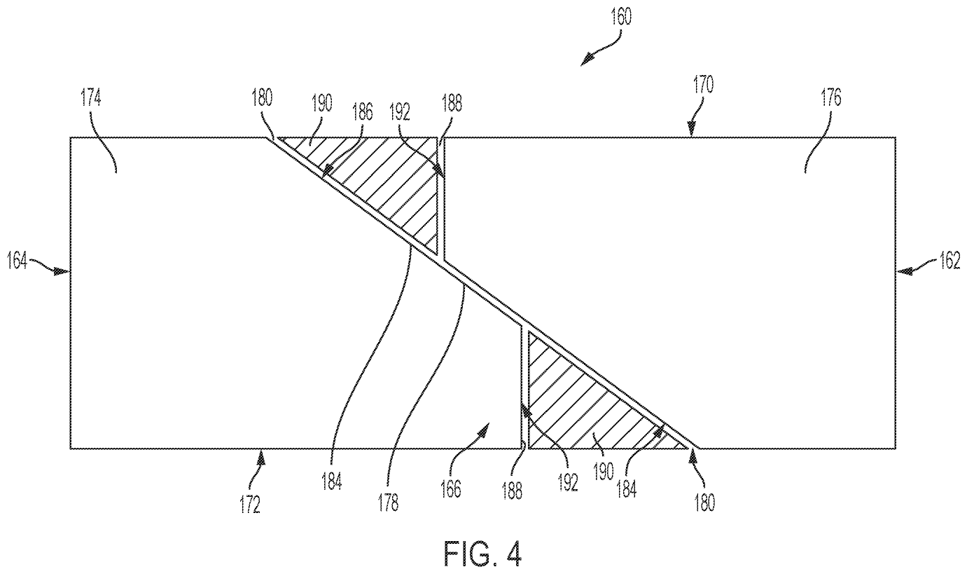

Once the metal block 160 has been forged or otherwise shaped into the rectangular prism, the metal block is processed through additional machining steps to produce a first intermediate blank 174 and a second intermediate blank 176. Referring to FIGS. 3 and 4, the first intermediate blank 174 and the second intermediate blank 176 can be identical in shape and size and can be formed by cutting the metal block 160 lengthwise between the upper face 170 and the lower face 172. Because the cutting process results in dividing the metal block 160 into first and second intermediate blanks 174, 176 of equal and congruent shape, size, and mass, it may be referred to as “bisecting” the metal block.

The metal block 160 can be cut 178 on a diagonal slant with respect to the first and second end faces 166, 168 to bisect the metal block into the first and second intermediate blanks 174, 176. However, rather than making the diagonal cut 178 between the intersection of the first lengthwise face 162 and the upper face 170 and the intersection of the second lengthwise face 164 and the lower face 172, the diagonal cut 178 can be offset rearward of the first lengthwise face 162 and offset forward of the second lengthwise face 164. Accordingly, the diagonal cut 178 passes though the upper face 170 and the lower face 172.

Because of the substantial size of the metal block 160, an appropriate cutting process can be used such as, for example, a band saw or circular blade saw supported on a frame or table that may include rollers or slides to maneuver the metal block with respect to the blade. Other suitable cutting methods include but are not limited to electric discharge machining, laser cutting, and plasma cutting.

In an embodiment, to guide and facilitate the cutting process used to form the diagonal cut 178, one or more guide grooves can be formed in the appropriate faces of the metal block 160. For example, these may include a pair of lengthwise grooves 180 extending across the upper and lower faces 170, 172, respectively, between the first and second end faces 166, 168 and parallel to the first and second lengthwise faces 162, 164. In addition, a pair of diagonal grooves 182 can be formed in the first and second end faces 166, 168, respectively, and that extends between the upper and lower faces 170, 172. The lengthwise grooves 180 and diagonal grooves 182 delineate and can guide the diagonal cut 178 to be made through the metal block 160.

As a result of the diagonal cut 178 to bisect the metal block 160 into the first and second intermediate blanks 174, 176, the intermediate blanks respectively include a first slanted face 184 and a second slanted face 186. The first and second slanted faces 184, 186 made by the diagonal cut 178 extend at an inclined angle between the upper and lower faces 170, 172. Because of the angled orientation of the first and second slanted faces 184, 186, a substantial portion of the upper face 170 remains as part of the first intermediate blank 174 and a substantial portion of the lower face 172 remains part of the second intermediate blank 176. The resulting first and second intermediate blanks 174, 176 can be shaped as trapezoidal cuboids or prisms in that the remaining portions of the upper face 170 and the lower face 172 are parallel and the remaining portions of the first and second end faces 166, 168 are parallel but the first and second lengthwise faces 162, 164 are nonparallel with respect to the respective first and second slanted faces 184, 186.

To reduce weight of the finished internal and external toothed segments, excess material can be removed from the first and second intermediate blanks 174, 176. For example, referring to FIG. 4, triangular cuts 188 can be made into the metal block 160 at locations parallel to where the diagonal cuts 178 intersects the upper and lower faces 170, 172. The triangular cuts 188 can extend the length of the metal block 160 with respect to the first and second lengthwise faces 162, 164. The triangular cuts 188 can result in the removal of triangular-shaped wedges 190 of metal from the metal block 160 proximate both the upper face 170 and the lower face 172. The triangular-shaped wedges 190 may become waste or scape metal for recycling.

Because of the triangular cuts 188 and removal of the triangular-shaped wedges 190, the cross-section of the first and second intermediate blanks 174, 176 can be that of a five-sided polygon in that each includes a lengthwise edge 192 formed by the triangular cut 188. The lengthwise edges 192 can be parallel to the first and second lengthwise faces 162, 164 and can extend the length of the metal block 160 between the first and second end faces 166, 168. Any suitable cutting technique can be used to form the triangular cut 188 including, for example, torch-cutting using a fuel and oxygen.

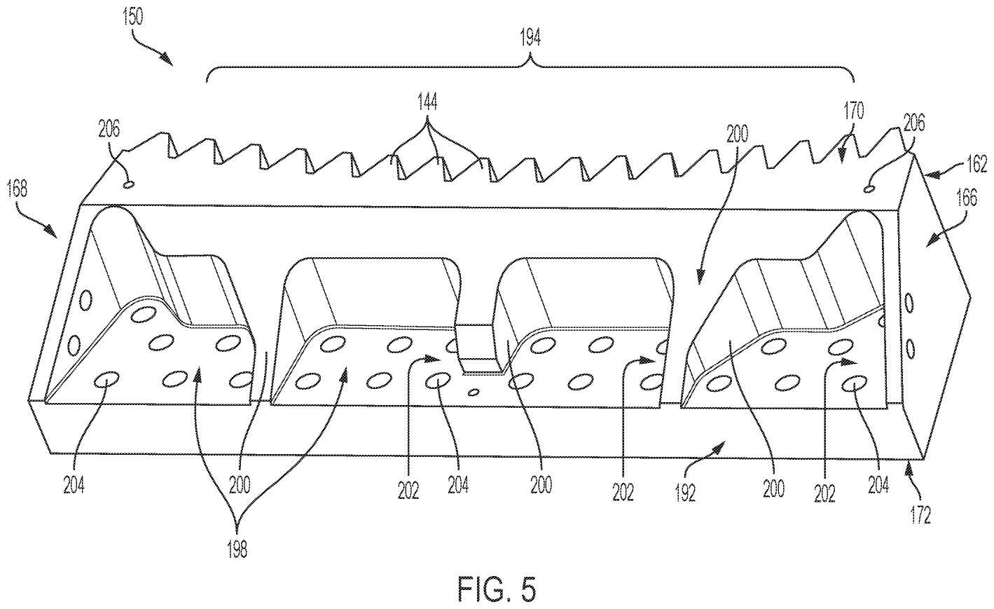

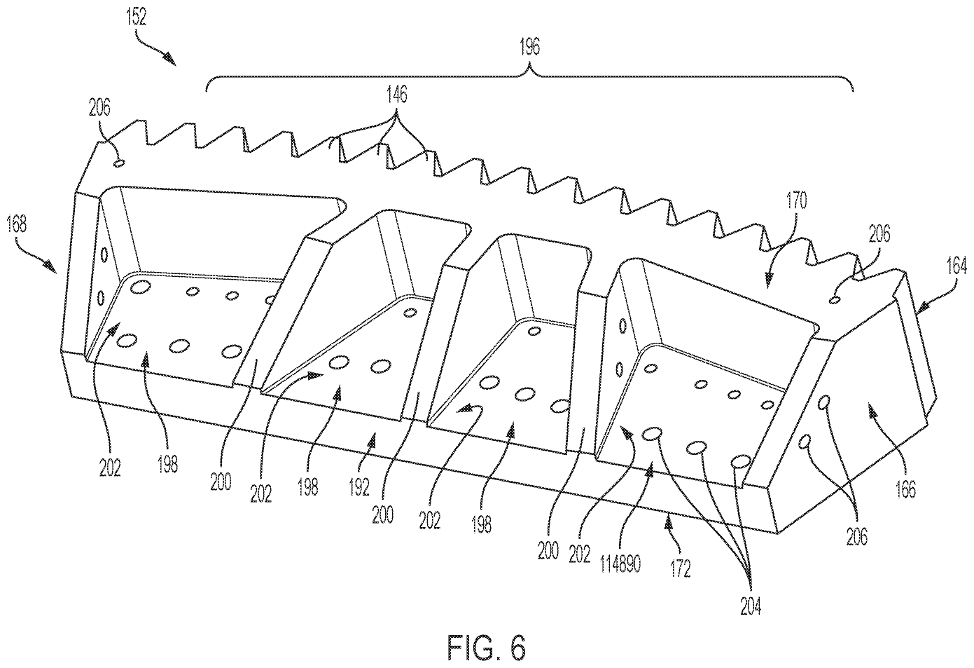

Additional machining and metalworking processes can be performed on the first and second intermediate blanks 174, 176 to form the finished parts corresponding to the internal and external toothed segments 150, 152 illustrated in FIGS. 5 and 6. By forming the finished internal and external toothed segments 150, 152 from the intermediate blanks 174, 176, the finished segments are unitary, integral parts of sufficient strength and rigidity for the intended application.

For example, the plurality of internal teeth 144 of the internal toothed segment 150 may be machined into the first and/or second lengthwise faces 162, 164 of the first and/or second intermediate blanks 174, 176. Likewise, the external teeth 146 of the external toothed segment 142 can be machined into the first and/or second lengthwise faces 162, 164 of the first and/or second intermediate blanks 174, 176. Because the internal toothed segment 150 is only a partial arc of the circumference of the finished outer gear ring, the internal teeth 144 are arranged as a plurality of concavely arranged teeth 194 that curve inward into the internal toothed segment 150. Similarly, the external teeth 146 are arranged as a plurality of convexly arranged teeth 196 that curve outwardly with respect to the external toothed segment 152.

The internal teeth 144 associated with the plurality of concavely arranged teeth 194 and the external teeth 146 associated with the plurality of convexly arranged teeth 196 can be machine into the first and second lengthwise faces 162, 164 of the respective first and second intermediate blanks 174, 176 by a suitable machining process. For example, while hobbing with a hob cutting tool is a machining process often used to remove metal from a blank to form gear teeth, because of the size of the first and second intermediate blanks 174, 176 and because the finished internal and external toothed segments 150, 152 are only a partial arc of some degrees of the complete internal and external gear rings, other metal removing processes like broaching and milling may be used in addition or instead.

In an embodiment, to further reduce weight of the finished internal and external toothed segments 150, 152 through the removal of excess material, a plurality of pockets 198 can be machined into the first and second intermediate blanks 174, 176. For example, a plurality of recesses or pockets 198 can be machined into the slanted face 184 of the first intermediate blank 174 corresponding to the internal toothed segment 150 generally in the axial direction by a peripheral milling process using a milling cutter. Another plurality of recesses or pockets 198 can be machined into the slanted face 186 of the second intermediate blank 176 corresponding to the external toothed segment 152 generally in an axial direction with a milling cutter. The plurality of pockets 198, for example, in the illustrated embodiment four pockets, can be linearly spaced along the lengthwise edge 192 generally adjacent to the plurality of concavely arranged or convexly arranged teeth 194, 196 and can have similar or dissimilar shapes.

Machining of the plurality of pockets 198 may define a plurality of structural supports 200 that are integrally fixed with respect to the finished internal and external toothed segments 150, 152 and that linearly separate the plurality of pocket 198 with respect to the lengthwise dimension of the internal and external toothed segments. The structural supports 200 can extend towards and are generally orthogonal or perpendicular with respect to the lengthwise edge 192 and generally have a downward sloping configuration The structural supports 200, which can be generally orthogonal or perpendicular to the plurality of concavely or convexly arranged teeth 194, 196, can radially brace the teeth as the inner and outer gear rings intermesh with the pinion that drives the swing assembly. The uppermost extension or surface of the plurality of structural supports 200 can correspond to the slanted faces 184, 186 created by the diagonal cut 178 described above. Accordingly, the structural supports 200 are inclined downwardly as they extend to the lengthwise edge 192 of the respective internal and external toothed segments 150, 152. The downwardly sloped structural supports 200 can serve to direct or transfer forces or loads applied to the concavely or convexly arranged teeth 194, 196 that the structural supports brace to the upper structure or lower base of the dragline excavator.

The plurality of pockets 198 can form a corresponding plurality of recessed bearing surfaces 202 into the internal and external toothed segments 150, 152 that are generally parallel to the remaining portions of the upper face 170 and the lower face 172. Disposed into the recessed bearing surfaces 202 can be one or more axial through holes 204 formed, for example, by drilling and adapted to receive threaded fasteners there through to secure the internal and external toothed segments 150, 152 to the lower base of the dragline excavator. Locating the axial through holes 204 in the recessed bearing surfaces 202 created by the pockets 198 has an advantage of shortening the length of fasteners used to secure the toothed segments to the lower base of the dragline excavator as appropriate. Washers may be used to spread the load of the fasteners over the recessed bearing surfaces 202. In addition to the axial through holes 204, to facilitate lifting and installation of the internal toothed segment 150 and external toothed segment 152, one or more threaded lifting holes 206 can be disposed at appropriate locations.

In a possible embodiment, to enable the arc-shaped internal gear segments 150 and the external gear segments 152 to be circumferentially aligned in an abutting arrangement and produce a circumferential circles associated with the internal gear ring and the external gear ring respectively, the first and second end faces 166 or 168 may be cut or milled at an angle between the lengthwise faces 162, 164 and the lengthwise edge 192. The first and second end faces 166 or 168 may be milled using an end mill or similar cutting tool.

### INDUSTRIAL APPLICABILITY

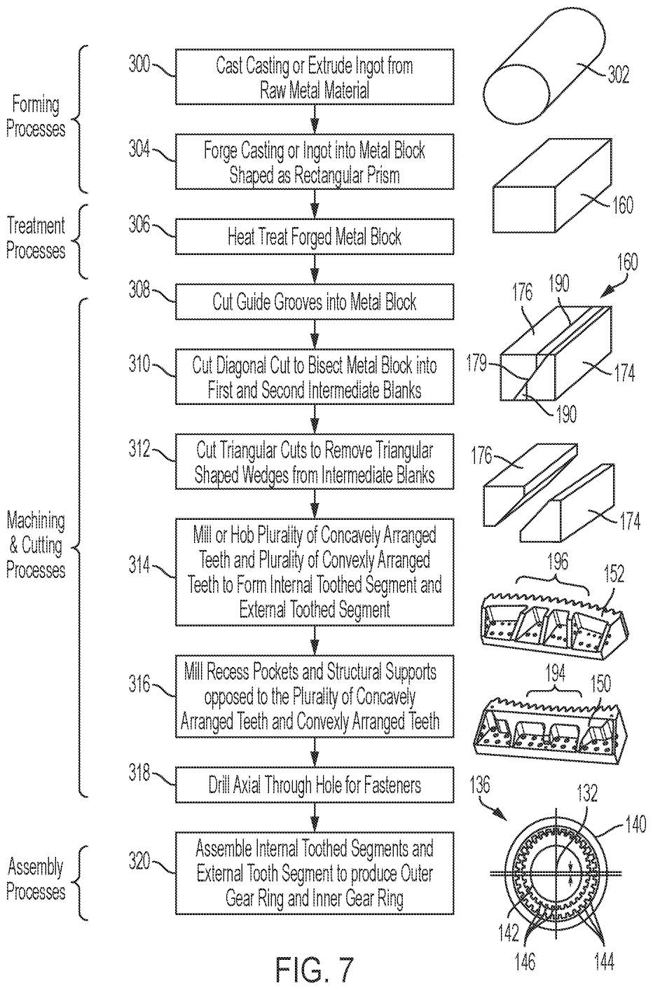

Referring to FIG. 7, there is illustrated a schematic diagram of a series of metalworking steps and processes that can be conducted to form and finish a plurality of internal toothed segments and external toothed segments that can manufactured together and selected for assembly into a large diameter swing gear assembly. The different steps and processes physically alter the metal material at different stages to produce the finished part. The schematic diagram in FIG. 7 is exemplary only, and the order of the individual steps and processes may change and particular steps and processes may be omitted or added. In addition to FIG. 7, the examples of metalworking and manufacturing processes will be explained with reference to FIGS. 3-4 illustrating the metal block 160 and FIGS. 5-6 illustrating the finished internal toothed segment 150 and finished external toothed segment 152.

In an initial forming process 300, raw metal material such as steel or iron is cast or extruded to form a raw casting or ingot 302. Casting and extrusion are considered to be types of bulk forming processes as familiar to persons of skill in the art of metalworking. Casting involves heating the metallic raw material, for example, iron ore or steel, to molten liquid that is poured into a mold or cast and cooled until solid. In extrusion, hot metal may be pushed through a die defining a desired cross-sectional shape to produce an ingot. The solid metal assumes the form of the mold, cast or, in the case of extrusion, assume the cross-section of the die, as indicated by the casting or ingot 302 in FIG. 7.

In a subsequent forging process 304, the casting or ingot 302 can be formed or worked to produce the metal block 160 in the shape of a rectangular prism. Forging may be considered a type of metal forming process in which the casting or ingot is further shaped by applying compressive forces to cause mechanical deformation. In forging and similar metal forming processes, the shape and physical properties of the metal work piece may be altered by physical deformation without removal of the metal material. The compressive forces may be applied by placing the casting or ingot in a die defining the desired shape and repeatedly striking the part, for example, with a forge press or power hammer. In an embodiment, the forging process 304 may be a hot forging process in which the casting or ingot is heated while being compressed to enable the microstructural grains or crystals of the metal to reform or adapt to the imparted shape. In addition to producing a desired shape, forging improves the strength of the metal through work hardening and alignment of molecules on microstructural scale. By way of example, the metal block 160 produced by the forging process 304 may be sized two or more meters in length by one or more meter in width by thirty centimeters or more in vertical height.

In an embodiment, the metal block 160 can undergo a heat treating process 306 in which the metal block is heated to an elevated temperature for a period of time and cooled. Heat treatment is a type of treatment process that alters the microstructural properties of the metal block 160 to improve strength, rearrange or reorder the molecular or atomic structure, or to achieve other physical properties. In an embodiment, the heat treating process 306 can be done to improve machinability of the metal block 160, for example, an annealing process that softens the metal block.

The metal block 160 may thereafter undergo a series of machining steps in which some metal is removed or cut away to product the finished parts. For example, to assist in subsequent machining, a groove forming process 308 can be conducted in which a plurality of guide grooves is cut into the metal block 160. This may include the lengthwise groove 180 and the diagonal grooves 182 described above. Cutting the guide grooves can be accomplished by an end mill or similar cutting tool. The lengthwise grooves 180 and diagonal grooves 182 may penetrate the respective face of the metal block 160 only by a few centimeters, but can function as an outline or guide for subsequent cutting processes.

To bisect the metal block 160 into the first and second intermediate blanks 174, 176 described above, a diagonal cut 178 can be made via a diagonal cutting process 310 in which a cutting tool like a band saw or blade saw is directed lengthwise through the metal block 160. Alternatively, the diagonal cutting process 310 can be conducted using a laser or a plasma torch or electrical discharge machining. The diagonal cutting process 310 produces the first and second intermediate blanks 174, 176 shaped as trapezoidal cuboids or prisms that have six opposing faces in which at least two opposing faces are non-parallel.

Another cutting process, in particular, a triangular cutting process 312 to produce the triangular cut 188 described above, can be conducted either before or after the first and second intermediate blanks 174, 176 have been separated from the metal block 160. The triangular cutting process 312 removes the triangular-shaped wedges 190 described above so that the resulting shape of the first and second intermediate blanks has the cross-section of a five-sided polygon. The triangular cutting process 312 can be accomplished with a plasma torch or a fuel-oxygen torch.

To produce the finished part from the first and second intermediate blanks 174, 176, further machining and, in particular, milling may be conducted to remove additional metal and produce the final shape. To produce the plurality of concavely arranged internal teeth 194 associated with the internal toothed segment 150, a gear milling process 314 or gear hobbing process can be conducted. The gear milling process 314 can be conducted by penetrating the lengthwise face 162 of the first intermediate blank 174 with a mill or hob to remove metal and shape the vertically arranged individual teeth. Similarly, the gear milling process 314 can be conducted on the lengthwise face 164 of the second intermediate blank 176 with a mill or hob to shape the plurality of convexly arranged teeth 196 associated with the external toothed segment 152. In an embodiment, either or both of the first and/or second intermediate blanks 174, 176 can be used to produce either or both of the internal toothed segment 150 and/or external toothed segment 152.

To reduce the weight of the internal and external toothed segments 150, 152 while producing the structural supports 200, a recessed milling process 316 can be conducted in which the plurality of pocket 198 are milled into the slanted faces 184, 186 of the first and second intermediate blanks 174, 176. The recessed milling process 316 can be conducted using an end mill or similar cutting tool. Because the resulting structural supports 200 are generally oriented orthogonally with respect to the pluralities of concavely and convexly arranged teeth 194, 196, the structural support 200 may brace and support applied loads during meshing of swing gear assembly and the pinion that drives rotation of the swing assembly.

To facilitate installation of the internal toothed segment 150 and the external toothed segment 152, a drilling process 318 an be conducted in which the plurality of axial through holes 204 are drilled with a drill bit into the recessed bearing surfaces 202 formed by the plurality of pockets 198. Additional metalworking processes can be conducted to produce the finished parts corresponding to the internal toothed segment 150 and external toothed segment 152 such as, for example, further heat treatment such as direct hardening, induction hardening or carburizing to improve strength, wear resistance, etc.

A final step may be an assembly process 320 in which the internal toothed segments 150 and external toothed segments 152 are transported and delivered to an excavation site for assembly into the swing assembly 130. A plurality of internal toothed segments 150 can be arranged and aligned to produce the circumference of the internal gear ring 140 that is concentrically located about the axis line 132 of machine rotation. Similarly, the plurality of external tooth segments 152 can be arranged to produce the circumference of the external gear ring 142 concentrically aligned about the axis line 132 of machine rotation. The internal and external toothed segments 150, 152, can be joined to adjacent segments by, for example, fasteners or welding. One of the assembled internal gear rings 140 or external gear rings 142 can be selected for assembly into the swing assembly of a dragline excavator or similar machine.

The disclosure therefore provides a swing gear assembly for large scale or heavy machinery which is assembled from a plurality of external and/or internal toothed segments. The external and internal toothed segments are manufactured via a series of metalworking processes intended to increase efficiency and reduce cost of manufacturing and to provide structural elements that may improve load-transfer ability and strength of the gear segments. These and other possible advantages and features of the disclosure are apparent to a person of skill in the art from the foregoing description and accompanying drawings.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

I claim:

1. A method of producing a swing gear set comprising:
forging a metal block from metal raw material, the metal block having a shape of a rectangular prism including a first lengthwise face and a second lengthwise face and an upper face and a lower face;
bisecting the metal block into a first intermediate blank and a second intermediate blank with a diagonal cut disposed between the upper face and the lower face;
milling a plurality of arranged teeth into the first lengthwise face of the first intermediate blank to produce one of an internal toothed segment and an external toothed segment; and
milling a plurality of arranged teeth into the second lengthwise face of the second intermediate blank to produce one of an internal toothed segment and an external toothed segment.

2. The method of claim 1, wherein the diagonal cut as made at the upper face is offset from the first lengthwise face and the diagonal cut as made at the lower face is offset from the second lengthwise face.

3. The method of claim 2, wherein the diagonal cut produces a first slanted face on the first intermediate blank inclined between the upper face and lower face and a second slanted face on the second intermediate blank inclined between the upper face and the lower face.

4. The method of claim 3, wherein the first intermediate blank and the second intermediate blank are shaped as a trapezoidal cuboid after the diagonal cut is made.

5. The method of claim 3, further comprising cutting a first triangular cut between the upward face and the first slanted face of the first intermediate blank to remove a first triangular wedge and cutting a second triangular cut between the lower face and the second slanted face of the second intermediate blank to remove a second triangular wedge.

6. The method of claim 5, wherein the first intermediate blank and the second intermediate blank each have a cross-section of a five-sided polygon after the first triangular cut and the second triangular cut.

7. The method of claim 5, wherein the first triangular cut produces a first lengthwise edge in the first intermediate blank between the upper face and the first slanted face, and the second triangular cut produces a second lengthwise edge in the second intermediate blank between the lower face and the second slanted face.

8. The method of claim 7, further comprising milling a plurality of pockets into the first slanted face of the first intermediate blank and into the second slanted face of the second intermediate blank.

9. The method of claim 8, wherein the plurality of pockets defines a plurality of structural supports on the first intermediate blank and the second intermediate blank, the plurality of structural supports on the first intermediate blank having upper extensions corresponding to the first slanted face and the plurality of structural supports on the second intermediate blank having upper extensions corresponding to the second slanted face.

10. The method of claim 1, wherein the metal block shaped the rectangular prism includes a first end face and a second end face, and the diagonal cut extends between the first end face and the second end face.

11. The method of claim 1, further comprising a plurality of guide grooves into the metal block, the plurality of guide grooves including lengthwise guide grooves in the upper face and the lower face and diagonal guide groove in the first end face and second end face.

12. The method of claim 1, further comprising heat treating the metal block between the step of forging the metal and the step of machining the internal or external teeth.

13. A gear set comprising:
a gear ring including a plurality of teeth, the gear ring comprised of at least:
a first toothed segment having a plurality of gear teeth disposed into a first lengthwise face of a first intermediate blank from which one of the plurality of the toothed segments is machined; and
a second toothed segment having a plurality of gear teeth disposed into a second lengthwise face of a second intermediate blank from which the one of the plurality of the toothed segments is machined; wherein
the first intermediate blank and the second intermediate blank are commonly bisected from a metal block.

14. The gear set of claim 13, wherein the first toothed segment and the second toothed segment each includes an upper face and a lower face parallel to each other and perpendicular to the lengthwise face of the first intermediate bland and second intermediate blank respectively.

15. The gear set of claim 14, wherein the first toothed segment includes a first slanted face and the second toothed segment includes a second slanted face produced when the first intermediate blank and second intermediate blank are bisected from the metal block

16. The gear set of claim 15, wherein the first slanted face extends diagonally from the upper face toward the lower face of the first intermediate blank and the second slanted face extends diagonally from the upper face toward the lower face of the second intermediate blank.

17. The gear set of claim 16, wherein the first toothed segment and the second toothed segment each include a plurality of pockets disposed into the first slanted face and the second slanted face respectively.

18. The gear set of claim 17, wherein the first slanted face and the second slanted face are structurally associated with a plurality of structural supports generally orthogonal to the plurality of gear teeth of the first toothed segment and to the plurality of gear teeth of the second toothed segment.

19. The gear set of claim 18, wherein each of the plurality of pockets defines a recessed bearing surface parallel with the upper face of the first toothed segment and the lower face of the second toothed segment with a plurality of axial through holes disposed between the recessed bearing surface and the upper face and lower face respectively.

20. A gear ring comprising:
a plurality of gear segments, each gear segment including an upper face, a lower face parallel to and spaced apart from the upper face, a lengthwise face extending between the upper face and the lower face and including a plurality of teeth disposed therein, a lengthwise edge parallel to and spaced apart from the lengthwise face and extending partially between the upper face and the lower face;
wherein the plurality of teeth is selected from the group comprising internal teeth concavely disposed in the lengthwise face and a plurality of external teeth convexly disposed in the lengthwise face.
